(19) United States
(12) Patent Application Publication
(10) Pub. No.: US 2026/0170589 A1
(43) Pub. Date: Jun. 18, 2026

(54) CONFIGURATION OF MULTI-INSTANCE GRAPHICS PROCESSING UNITS

(71) Applicant: INTERNATIONAL BUSINESS MACHINES CORPORATION, Armonk, NY (US)

(72) Inventors: Kaustabha RAY, Bangalore (IN); Umamaheswari DEVI, Bangalore (IN); Felix GEORGE, Kannur (IN)

(21) Appl. No.: 18/980,508

(22) Filed: Dec. 13, 2024

(51) Int. Cl. G06T 1/20

(52) U.S. Cl. CPC G06T 1/20

(57) ABSTRACT

Computer implemented methods, systems, and computer program products include program code executing on a processor(s) obtains a service invocation for MIG resources for a service. The invocation comprises a specification defining parameters for the service. The program code encodes the specification and determines, based on accessing historical data, configuration choices for MIG configurations instances based on an edge site of the distributed computing system. The program code evaluates, utilizing the encoded specification and a Discrete Time Markov Chain (DTMC), the service invocation in a context of temporally relevant service invocations in the distributed computing system targeting the edge site. The program code determines execution metrics for the service based on the configuration choices and the evaluation of the service invocation, where the execution metrics satisfy the specification with high probability. The program code determines a MIG configuration instance for the service and executed the service utilizing the MIG configuration instance.

### BACKGROUND

The present invention relates generally to the field of resource configuration in a complex computing environment, specifically, to determining configuration instances for multiple instance graphics processing units (GPUs).

A GPU is a specialized electronic circuit initially designed for digital image processing and to accelerate computer graphics, being present either as a discrete video card or embedded on motherboards, mobile phones, personal computers, workstations, and game consoles. After their initial design, GPUs were found to be useful for non-graphic calculations involving parallel problems due to their parallel structure. GPUs, due to their specialized hardware, can perform mathematical calculations quickly and in parallel, making them ideal for tasks like machine learning (ML), video editing, and graphics rendering.

A multi-instance or multiple instance GPU (MIG) is a feature that allows a single physical GPU to be partitioned into multiple independent instances. In a MIG, each instance has its own dedicated resources, such as GPU memory, compute, and cache, and is isolated from the others. MIGs enable multiple workloads to run on a single GPU without interfering with each other. Because a MIG enables a single GPU to be partitioned into multiple instances, the MIG provides a high degree of scalability and flexibility. In some implementations, a MIG partitions a GPU into as many as seven instances. Each instance is fully isolated from any other instance. Each instance has its own high-bandwidth memory, cache, and computation cores.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Neural networks (NNs) refer to a biologically inspired programming paradigm which enables a computer to learn from observational data. This (machine) learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modelling tools. They are usually used to model complex relationships between inputs and outputs or to identify patterns in data (i.e., neural networks are non-linear statistical data modelling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Large language models (LLMs) are deep learning models that are pre-trained on vast amounts of data. The underlying transformer for an LLM is a set of NNs that consist of an encoder and a decoder with self-attention capabilities.

### SUMMARY

Shortcomings of the prior art are overcome, and additional advantages are provided through the provision of a computer-implemented method for determining multiple instance graphics processing unit (MIG) configuration instances in a distributed computing system. The method can include: obtaining, by one or more processors, a service invocation for MIG resources for a service, wherein the service invocation comprises a specification defining performance parameters for the service; encoding, by the one or more processors, the specification; determining, by the one or more processors, based on accessing historical data, configuration choices for MIG configurations instances based on an edge site of the distributed computing system; evaluating, by the one or more processors, utilizing the encoded specification and a Discrete Time Markov Chain (DTMC), the service invocation in a context of temporally relevant service invocations in the distributed computing system targeting the edge site; determining, by the one or more processors, execution metrics for the service based on the configuration choices and the evaluation of the service invocation, wherein the execution metrics satisfy the specification with high probability; based on the execution metrics, determining a MIG configuration instance for the service; and executing, by the one or more processors, the service utilizing the MIG configuration instance.

Shortcomings of the prior art, are overcome, and additional advantages are provided through the provision of a computer program product for determining multiple instance graphics processing unit (MIG) configuration instances in a distributed computing system. The computer program product comprises a storage medium readable by one or more processors and storing instructions for execution by the one or more processors for performing a method. The method includes, for instance: obtaining, by the one or more processors, a service invocation for MIG resources for a service, wherein the service invocation comprises a specification defining performance parameters for the service; encoding, by the one or more processors, the specification; determining, by the one or more processors, based on accessing historical data, configuration choices for MIG configurations instances based on an edge site of the distributed computing system; evaluating, by the one or more processors, utilizing the encoded specification and a Discrete Time Markov Chain (DTMC), the service invocation in a context of temporally relevant service invocations in the distributed computing system targeting the edge site; determining, by the one or more processors, execution metrics for the service based on the configuration choices and the evaluation of the service invocation, wherein the execution metrics satisfy the specification with high probability; based on the execution metrics, determining a MIG configuration instance for the service; and executing, by the one or more processors, the service utilizing the MIG configuration instance.

Shortcomings of the prior art are overcome, and additional advantages are provided through the provision of a system for determining multiple instance graphics processing unit (MIG) configuration instances in a distributed computing system. The system includes: a memory, one or more processors in communication with the memory, and program instructions executable by the one or more processors via the memory to perform a method. The method includes, for instance: obtaining, by the one or more processors, a service invocation for MIG resources for a service, wherein the service invocation comprises a specification defining performance parameters for the service; encoding, by the one or more processors, the specification; determining, by the one or more processors, based on accessing historical data, configuration choices for MIG configurations instances based on an edge site of the distributed computing system; evaluating, by the one or more processors, utilizing the encoded specification and a Discrete Time Markov Chain (DTMC), the service invocation in a context of temporally relevant service invocations in the distributed computing system targeting the edge site; determining, by the one or more processors, execution metrics for the service based on the configuration choices and the evaluation of the service invocation, wherein the execution metrics satisfy the specification with high probability; based on the execution metrics, determining a MIG configuration instance for the service; and executing, by the one or more processors, the service utilizing the MIG configuration instance.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 illustrates a non-limiting example of various MIG configuration choices provided to contextualize aspects of some embodiments of the present disclosure;

FIG. 3 provides an overview of program code in some embodiments of the present disclosure synthesizing MIG configuration instances for services;

FIG. 4 illustrates a model of GPU configurations relevant to some embodiments of the present disclosure;

FIG. 5 illustrates a model of service invocations relevant to some embodiments of the present disclosure;

FIG. 6 represents a model of metric execution relevant to some embodiments of the present disclosure; and

FIG. 7 illustrates edge sites sharing a load in accordance with some embodiments of the present disclosure.

### DETAILED DESCRIPTION

The examples herein include computer-implemented methods, computer program products, and computer systems where program code executing on one or more processors determine and implement MIG GPU configuration instances. GPU instances are virtual machines (VMs) equipped with GPUs specifically designed to handle intensive computation tasks, such as those found in machine learning and deep learning applications. In the examples herein, the program code configures MIG GPU instances to comport with various requirements, including but not limited to service level agreement (SLA) requirements, and are determined and implemented based, in part, on historical processing distributions. In the examples herein, the program code generalizes to edge sites where multiple edge sites can collaborate and share resources. The program code generalizes and hence determines configurations based on concurrent stochastic game (CSG) methodology and automatically utilizing reinforcement, learning (RL). In the examples herein, to determine and implement MIG GPU configuration instances, program code automatically (and continuously) determines an optimal strategy for a coalition of edge sites based on automatically (and continuously) learning a number of edge sites to include in the coalition.

In the examples herein, determine and implement MIG GPU configuration instances, the program code in the examples herein can utilize CSG, RL, a Markov Decision Process, and identifies edge sites or locations. In general, a CSG is an n-player game which models probabilistic systems with multiple players or components that make rational decisions concurrently. In a CSG, in each round, players simultaneously choose actions on a graph, and these actions determine a transition to a probability distribution over successor states. CSG are used to model probabilistic systems that feature multiple players or multiple components with distinct objectives making concurrent, rational decisions. CSGs have been used to model communication and/or security protocols. In certain of the examples herein, the program code models MIGs as players in a CSG. Meanwhile, RL is a machine learning technique that teaches program code (e.g., software) to make decisions that maximize rewards in a dynamic environment. To that end, program code comprising RIL agents interact with a computing environment, observe the results within this environment, and learn which actions yield the best rewards. An RL agent learns from the feedback of each action and can consider both immediate and delayed rewards. In the examples herein, the program code utilizes RL to determine a coalition of edge sites for multi-objective satisfaction (e.g., including SLA satisfaction). The program code in the examples here generalizes to edge sites, meaning that the program code in the examples herein can function effectively and perform well across a variety of edge locations in the distributed computing environment. Edge sites are distributed computing points situated close to a source of data. An edge site of a distributed computing environment can be understood as a geographically distributed data center. Each data center is at a different physical location. In the examples herein, the program code generalizes to edge sites so that multiple edge sites can collaborate and share MIG partitions. In the examples herein, program code executing on one or more processors models MIG configuration search spaces as a Markov Decision Process (MDP, a model for sequential decision making when outcomes are uncertain). The GPU search space is a range of possible solutions or combinations within a problem that can be efficiently explored using the parallel processing power of a Graphics Processing Unit (GPU), where the large number of cores on a GPU allow for simultaneous calculations on multiple parts of the search space (e.g., significantly accelerating the search process compared to a standard central processing unit (CPU).

Embodiments of the present invention are inextricably tied to computing and are directed to a practical application. The examples herein provide a computer-based solution to an issue in computing. Although GPUs provide functionality in computing environments, including in distributed computing environments such as cloud computing environments, that CPUs and other processing units cannot provide or cannot provide or cannot provide as efficiently or effectively, GPUs utilize a large amount of power (proportionally when compared to other resources) in distributed computing systems and thus, processing efficacy and efficiency can be increased through conservation of energy, as related to GPUs, as well as maximizing GPU sharing among system users. The examples herein enable power conservation and resource sharing within distributed computing environments, such as cloud computing environments, and for at least this reason, are inextricably tied to computing.

The examples herein provide significantly more than existing approaches to GPU instance configuration for increasing processing efficiency while conserving power and optimizing resource usage. For example, existing approaches to resource conservation in distributed computing environments do not utilize program code to determine MIG GPU configuration instances required to satisfy multi-objective SLA requirements with respect to a historical distribution nor do these existing approaches utilize a trained RL model to select coalitions to use for the historical distribution. The existing approaches also do not generalize edge sites and utilize multiple edge sites to collaborate and share MIG partitions. The existing approaches do not apply a model that includes automatically learn a CSG using RL nor is MDP part of the configurations process. The examples herein utilize these unique components and/or combinations of these unique components to enable efficient resource allocation and resource sharing within a framework that provides resources to multiple users of the shared environment. The examples herein provide significantly more at least because although approaches exist that design policies for scheduling workloads to optimize various metrics, these approaches, unlike the examples herein, do not consider multi-instance GPU configuration determination. Hence, the computer-implemented methods, computer program products, and computer systems disclosed herein provide significantly more because they consider multi-instance GPU configuration determination in implementing design policies to schedule workloads to optimize various metrics.

The examples herein include computer-implemented methods, computer program products, and computer systems where program code executing on one or more processors determines multiple instance graphics processing unit (MIG) configuration instances in a distributed computing system. In some examples, the program code obtains a service invocation for MIG resources for a service, where the service invocation comprises a specification defining performance parameters for the service. The program code encodes the specification. The program code determines, based on accessing historical data, configuration choices for MIG configurations instances based on an edge site of the distributed computing system. The program code evaluates, utilizing the encoded specification and a Discrete Time Markov Chain (DTMC), the service invocation in a context of temporally relevant service invocations in the distributed computing system targeting the edge site. The program code determines execution metrics for the service based on the configuration choices and the evaluation of the service invocation, where the execution metrics satisfy the specification with high probability. Based on the execution metrics, the program code determines a MIG configuration instance for the service. The program code executes the service utilizing the MIG configuration instance.

In some examples, the program code returns execution results.

In some examples, the specification is a service level agreement.

In some examples, determining the configuration choices for the MIG configurations instances comprises the program code applying a Markov Decision Process.

In some examples, the historical data comprises data related to graphics processing units in the distributed computing system, the data selected from the group consisting of: benchmarks and logs.

In some examples, determining the execution metrics comprises applying another DTMC.

In some examples, determining the MIG configuration instance for the service further comprises: the program code determining that utilizing the edge site as a sole edge side to execute the service is suboptimal based on the specification. The program code automatically determines an optimal strategy for utilizing a coalition of edge sites to execute the service. The program code utilizes the coalition of edge sites to execute the service in the MIG configuration instance.

In some examples, the program code automatically determines the optimal strategy comprises applying a trained reinforcement learning algorithm.

In some examples, the program code implements a feedback loop to continuously train the reinforcement learning algorithm based on historical data comprising results of the service invocation.

In some examples, the configuration choices for the MIG configurations instances comprise steady states, wherein each steady state comprises a value for each instance of a given graphics processing unit at the edge site.

In some examples, each graphics processing unit is partitioned into a maximum of seven instances.

In some examples, each instance comprises a graphics processing cluster slice.

In some examples, the configuration choices for the MIG configuration instances comprise adding, retaining, or deleting a graphics processing cluster slice for each graphics processing cluster slice of a MIG.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

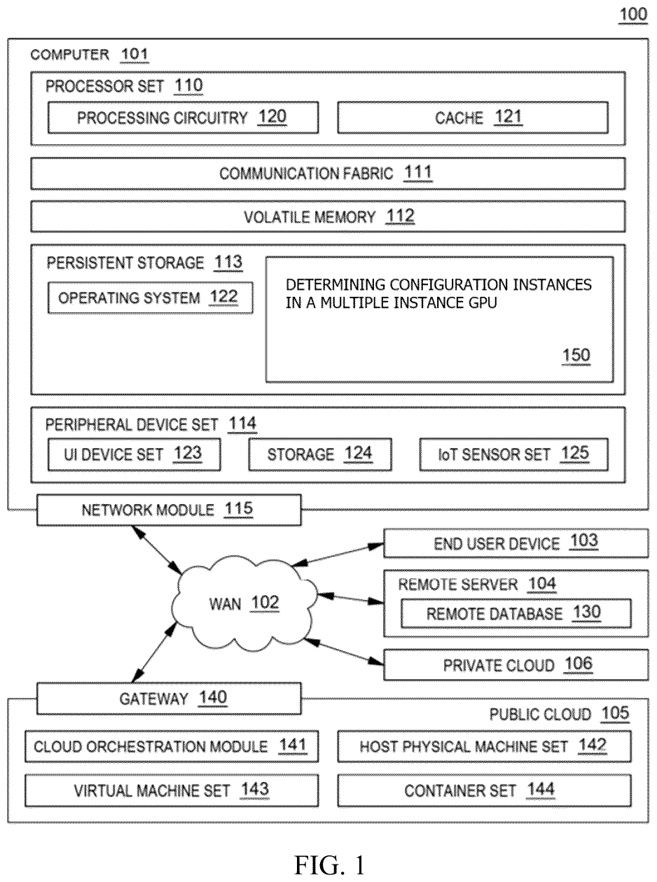

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for determining configuration instances in a multiple instance GPU 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the ail of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 10), at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments. UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares. CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but, the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

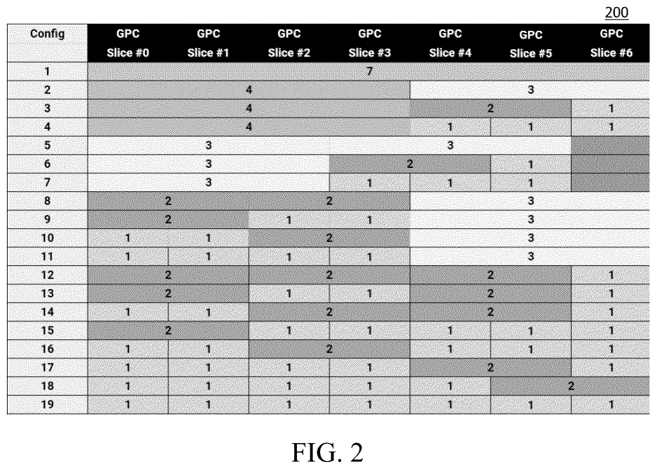

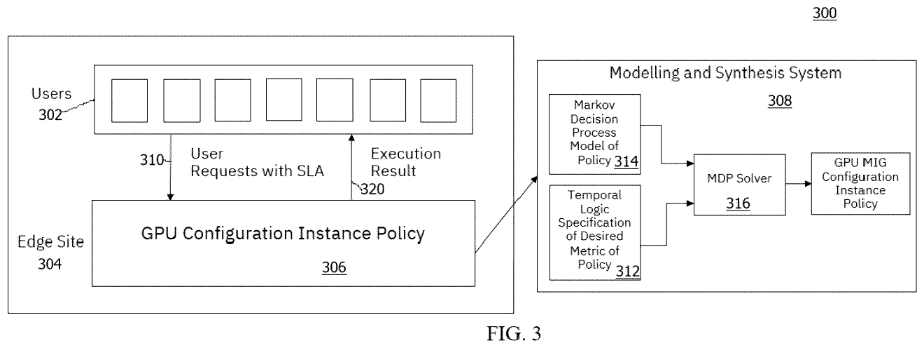

The examples herein include computer-implemented methods, computer program products, and computer systems, where program code executing on one or more processors implements a methodology for determining MIG GPU configuration instances which can satisfy multiple objective SLA requirements with respect to an historical distribution. In implementing this methodology, the program code utilizes CSG theory, which the program code automatically learns via RL. To illustrate aspects of the examples herein, FIG. 2 is provided to depict MIG configuration choices while FIG. 3 provides an overview of program code in the examples herein synthesizing MIG configuration instances for services (e.g., executed on the GPU resources of the computing environment).

FIG. 2 illustrates a non-limiting example of various MIG 200 configuration choices. In this example, a MIG partitions a GPU into seven instances or slices (e.g., slices 0-6). Each instance is fully isolated from any other instance. Each instance has its own high-bandwidth memory, cache, and computation cores. A MIG is a collection of VM instances that can be managed as a single entity. MIGs support various features, including but not limited to, auto-healing, autoscaling, load balancing, multiple zone coverage, and stateful workloads. Each MIG slice can be understood as a graphics processing cluster (GPC), which is a hardware block in a GPU that performs core graphics functions. GPCs are responsible for distributing workloads and managing resources across a GPU. Each slice denotes 1/7^{th} of a GPU. In some of the configurations, more than one slice or instance was assigned to a given user or client. For a given set of users, each with a priority, program, code in the examples herein can determine the number of instances of each MIG partition to assign to the given user so that a desired SLA property is satisfied with high probability. The high probability can be a pre-defined benchmark. The program code can determine, for each GPU (e.g., 1G, 2G, etc.) the number of instances for each user (e.g., 3×10, 2×2G, 1×7G).

The program code in the examples herein synthesizes MIG configuration instances for services. FIG. 3 provides a high-level illustration 300 of certain aspects of the examples herein, in which program code executing on one or more processors determines configuration instances for M IGs in shared and/or distributed computing environments, including but not limited to, cloud computing environments. Various functionalities in the examples herein are grouped into separate systems of modules for case of understanding. This example is provided for illustrative purposes only and the functionalities characterized as systems can be provided by one or more different systems or modules depending on the implementation in a computing environment.

As illustrated in FIG. 3, a group of users 302 utilize resources in a computing environment including requesting GPU utilization from an edge site 304 (310). Each user in the group of users 302 has SLA requirements, and the program code determines the number of instances in each MIG partition is needed for the particular service (of each SLA), such that a desired SLA property is satisfied with high probability principle. To determine the instances to assign to a given service (e.g., how to configure a given MIG), the program code in the examples herein can obtain data related to GPUs in the computing system utilized by the users via logs and/or benchmarks, based on program code in the examples herein accessing benchmarks and/or logs (e.g., historical data). The data can include a GPU profile or identifier (e.g., 1G), a description of the service itself (e.g., an LLM model including an LLM which takes a sequence of words as an input and predicts a next word to recursively generate text), and prior results related to the service execution such as arrival rate, median latency, and/or various metrics.

In FIG. 3, the program code obtains users requests for GPU instances (MIG instances) for services and each service has parameters defined by an SLA (310). Based on a GPU configuration instance policy 306 implemented by program code executed on one or more processors of the computing environment, the program code provides execution results from the edge site 304 (320). The GPU configuration instance policy 306 is generated by the program code based on program code comprising a modelling and synthesis system 308. The program code obtains as inputs a temporal logic specification of a desired policy metric 312 (the derivation of this input is discussed in greater detail herein) and an MDP model of policy 314 and provides these inputs to an MDP solver 316. Program code of the MDP solver 316 generated the GPU configuration instance policy 306 which provides the execution result to a user (e.g., runs the service and provides results). GPU configuration instance policy 306 generates the configuration for each service (which is provided to a requesting user). Each edge site 304 is modeled by the program code in the modelling and synthesis system 308. Although FIG. 3 illustrates the use of one edge site, the functionality illustrated in FIG. 3 can be extended to modelling interactions between various edge sites to share loads. The complete system can be understood as a CSG.

The MIG configuration instances for services generated by the program code in the examples herein account for various characteristics of the services (which utilize the GPUs) and the GPU assets themselves. The program code utilizes and accounts for, in its processing user requests for GPU resources: the stochastic nature (e.g., inherent randomness and unpredictability of the service invocation (by a user), the combination of choices of GPU modes (GPU modes control GPU allocation within the system), stochastic nature of resulting metrics (machine learning accounts for historical data and a feedback loop consistently trains RIL algorithms), and users with varying SLA requirements. To account for these factors in configuring instances for services, the program code applies a labeled MDP to synthesize MIG configuration instances for services. In addition to providing both single and multiple objective analysis in synthesizing configuration instances, the program code in the examples herein applies non-determinism in modelling MIG configuration choices, stochasticity to model service invocation and execution metrics (e.g., throughput, etc.), and rewards to capture tradeoffs between resource usage and resulting metrics.

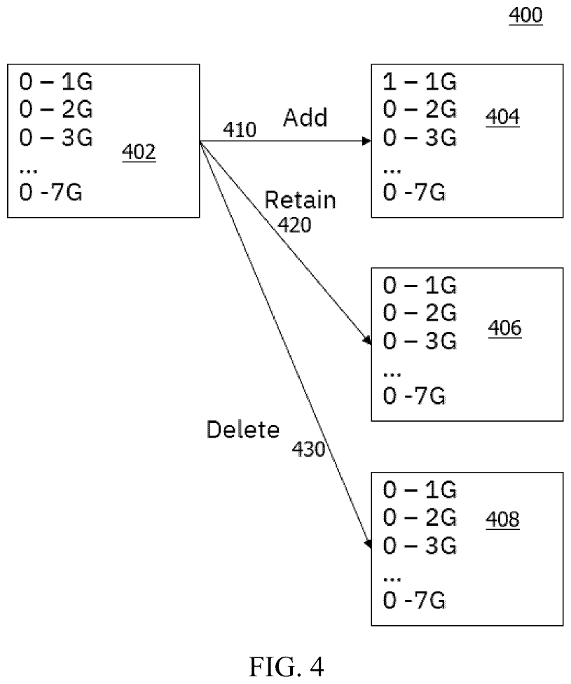

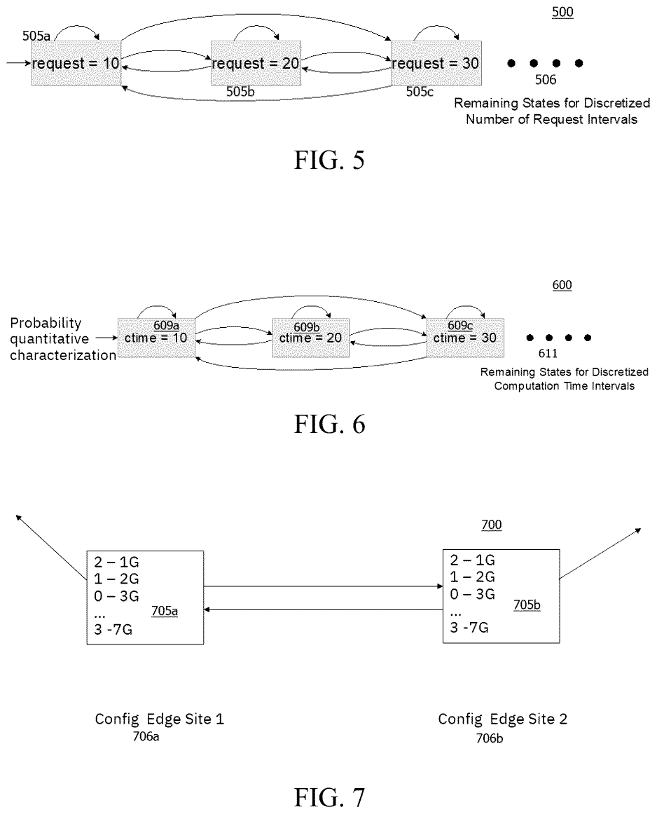

As illustrated in FIG. 3, the program code accounts separately for each edge site 304 in the computing system. As such, the program code constructs a model of a policy for each edge site 304. Thus, the program code constructs an MDP taking each edge or edge site into account independently. The program code can encode a requirement as a specification. The model (e.g., modelling and synthesis system 308) is composition based and comprises three MDPs: 1) an MDP of configuration choices; 2) a Discrete Time Markov Chain (DTMC) of service invocation; and 2) a DTMC of execution metrics that is conditional on the first and second MDPs. A DTMC is a stochastic process where the probability of transitioning to the next state depends only on the current state, not on any previous states, and where time progresses in discrete steps (e.g., individual time points, not continuous). The memory of a DTMC is limited to the present state. The program code configures MIG instances using a composition-based approach. The first MDP decides the configuration choices, the second DTMC (an MDP), is for service invocations, and the third DTMC (also an MDP) is a chain of execution metrics based conditionally on the first two models. The program code in the examples herein essentially utilizes a composed MDP to find configurations with respect to the specification, which is encoded by the program code as SLA requirements and solved using an MDP solver to determine MIG instance configuration. The model solution (solution of the composition-based on three MDPs) and the specification (e.g., a desired execution metric and or an SLA with a probability bound) are utilized by the program code to generate the GPU configuration instance policy 306. To illustrate the model applied by the program code in the examples herein, FIG. 4 illustrates the first MDP, an MDP model of GPU configuration, FIG. 5 represents the second MDP, a DTMC model of service invocations, and FIG. 6 represents the third MDP, a DTMC model of metric execution.

FIG. 4 illustrates an MDP model of GPL configurations relevant to the examples herein, the first portion of the three-part composition in the examples herein. A state space is a mathematical representation of all possible configurations or states a system can be in, where each state is defined by a set of variables and can be visualized as a point within this space. It is a complete description of a system at any given time, allowing analysis of how it changes and transitions between different states. FIG. 4 is a state-space representation 400 MIG configurations. In FIG. 4, 1G-7G represent instances or slices of a MIG. The program code in the examples herein can generate the instance configurations based on analyzing service requests utilizing the GPU configuration instance policy (e.g., FIG. 3, 306). In a lockstep, program code comprising the described MDP decides on the number of instances, (e.g., +−1/0) for each MIG configuration slice (e.g., instance, of the seven as illustrated in FIG. 2). The program code can add, retain, and delete (provided there is already as allocation), to generate a MIG configuration for an instance in order to allocate the instance (or de-allocate the instance) to a service (based on a service request from a user). FIG. 4 illustrates actions specifically for 1G (a given GP slice or instance) for ease of understanding, although the program code follows the same logic for each slice from 1G-7G.

As illustrated in FIG. 4, in an initial MIG configuration or state space 402 illustrates, pre-request, that no slice is allocated to a service (e.g., 0-1G, 0-2G, 0-3G . . . 0-7G). The program code can add a MIG slice to support service (410) and based on adding, a new configuration 404 includes the 1G slice of the MIG (e.g., 1-1G, 0-2G, 0-3G . . . 0-7G). The program code, responsive to the request, can also retain (420) the existing state-space (configuration), so that a later state 406 is identical to the initial configuration 402 (e.g., 0-1G, 0-2G, 0-3G . . . 0-7G). Should the program code determine that a slice should be deleted (430), based on the initial MIG configuration or state space 402, deleting a slice is not possible as there is no slice allocated; the configuration is at a guarded minimum value 408.

FIG. 5 illustrates a DTMC model of service invocations (applied by the program code in the examples herein). In certain of the examples herein, the state-space (illustrated in FIG. 4), corresponds to a stochastic distribution of service invocation rate. The program code utilizes the DTMC model of servicing locations for modelling service request generation. For ease of understanding, in this example the number of requests is discretized into blocks of a common amount, where 10 is the amount chosen in the non-limiting example illustrated in FIG. 5. Three request blocks 505a-505c are illustrated although additional remaining states for discretized number of request intervals are indicated 506. Thus, there is a state corresponding to each block of 10 requests. The transitions between the requests represent probability distribution over the number of requests. Thus, there are transitions from each single state to each single other state.

FIG. 6 represents a DTMC model of metric execution utilized by the program code which is conditional on the earlier MDPs. The program code determines a probability of quantitative characterization. Because the DTMC in FIG. 6 is conditional on the earlier MDPs, in this example, state-space corresponds to stochastic distribution of computation execution time (discretized) conditional on the configuration. Specifically, the metrics are governed by the actions of the MDP that are subject to the service invocations by the DTMC. The DTMC illustrated in FIG. 6 is a metric execution that is similar to the request generation DTMC but the probability distributions 609a-609c in this example characterize the previous two models. The remaining states for discretized computation time interval 611 are also illustrated. The MDP illustrated in FIG. 4 selects a number of GPU slices and the DTMC of FIG. 5 selects a number of requests (which would be fulfilled with the selected GPU slices). Thus, the number of probability distributions is dependent on the number of actions as well as combination of actions that are possible (as performed by the MDP), as well as the number of discretized states in the earlier DTMC related to services. Hence, the DTMC model of FIG. 6 is characterized by a conditional probability distribution. The program code (of the model as a whole) identifies a steady state (e.g., configuration) for which the expected value of the SLA (satisfaction) is optimized. Input distribution is characterized by the DTMC of service request invocation (FIG. 5) and the impact of the state on SLA is characterized by the DTMC for metric execution (FIG. 6).

FIGS. 4-6 illustrated various aspects of the modelling and synthesis system 308 (e.g., the combination of MDPs executed by program code). However, aspects of the examples herein also include generating the input to the modelling and synthesis system 308, a temporal logic specification of a desired policy metric 312, and utilizing RL to determine whether edge sites in the distributed system can share a load (when MIGs are configured to handle service requests). These aspects are described herein, and FIG. 7 illustrates edge sites sharing a load.

In the examples herein, the program code finds this steady state (e.g., configuration) by characterizing the SLA by formally using temporal logic specifications. As illustrated in FIG. 3, the program code obtains as inputs a temporal logic specification of a desired policy metric 312 and an MDP model of policy 314 and provides these inputs to an MDP solver 316. The program code generates this temporal logic specification. In some examples, herein, program code executing on one or more processors obtains request details (e.g., SLA) and analyzes the policy by utilizing Probabilistic Computation Tree Logic (PCTL), an extension of computation tree logic which enables probabilistic quantification of properties. The program code encodes desired metric(s) of the policy as a PCTL specification define by Equation 1 and Equation 2 below.

$$Φ \text{::} = true \vert a \vert ¬ Φ \vert ΦΛΨ \vert {P}_{∼ p} [ ϕ ] \vert {R}_{∼ p} [ ϕ ] \qquad ( Equation 1 )$$

$$ϕ \text{::} = X Φ \vert {ΦU}^{\leq K} Ψ \qquad ( Equation 2 )$$

Multi-objective properties are specified as multi(φ). Each state is associated with a reward value that is defined in terms of the labels, formally, Rewards: State→ [symbol] . R A reward characterizes resource consumption and is an analogue to cost.

The program code in the examples herein utilizes a game-based approach that is a model of each of the edge sites as a concurrent stochastic queue which the program code formulates using the temporal logic specification. In the examples herein, the program code enables the edge sites to collaborate amongst each other to ensure adherence to SLA specifications. The edge sites can share a load for a service amongst each other. For example, the program code can route an incoming load targeting one edge site to another edge site. Utilizing a local edge site for a service may not be optimal and by combining edge sites to provide a service (that utilizes resources of GPUs) can produce an optimally run service. In order to determine which edge sites to utilize for a given MIG instance, the program code applies Reinforcement Learning (RL) methodology. In some examples, the program code executing the RL logic can be referred to as an RL agent. The program code comprising the RL agent can determine the number (and which) edge sites will participate in a coalition. The program code then applies a model checked to solve this game-based approach (e.g., game). The program code returns a value (output of solving), and the program code utilizes this as a reward function and on the sample values from a data set distribution. Rewards are updated according to the learning equation.

FIG. 7 illustrates a portion of a computing environment 700 where edge sites are sharing a load associated with a configured MIG instance. An impetus for the sharing can be that the program code determines that an independent configuration determination is not optimal globally. This condition can arise due to heterogeneous device characteristics; in a homogeneous case an independent configuration is optimal. FIG. 7 illustrates two steady states or configurations 705a-705b (2-1G, 1-2G, 0-3G . . . 3-7G), each at an edge site 706a-706b. The program code can model the edge sites sharing a load as a concurrent stochastic game with coalitions (e.g., <<edge site 1, edge site 2> temporal logic specification). The program code can consider each edge site 706a-706b as a player who invokes services. The number of coalitions can be exponential, and the program code utilizes RL to determine these coalitions.

In the examples herein, program code comprising an RL agent learns which coalitions to use for the historical distribution. The state space of RL agents is all possible coalitions (e.g., 2\hat{ }edge sites). The program code therefore utilizes hierarchical RL for splitting the edge sites based on latency requirements (as noted earlier, latency is available to the program code). The program code comprising the RL agent for an application makes a choice. The program code executed a CSG for a coalition (e.g., <<site1, site2, . . . >>) and returns a reward function on sampled values from the distribution. The program code updates the rewards according to Q-Learning RL (e.g., a model-free reinforcement learning algorithm that teaches an agent to assign values to each action it might take, conditioned on the agent). Thus, the program code can learn coalitions to use for the historical distribution.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from the spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of determining multiple instance graphics processing unit (MIG) configuration instances in a distributed computing system, the method comprising:
obtaining, by one or more processors, a service invocation for MIG resources for a service, wherein the service invocation comprises a specification defining performance parameters for the service;
encoding, by the one or more processors, the specification;
determining, by the one or more processors, based on accessing historical data, configuration choices for MIG configurations instances based on an edge site of the distributed computing system;
evaluating, by the one or more processors, utilizing the encoded specification and a Discrete Time Markov Chain (DTMC), the service invocation in a context of temporally relevant service invocations in the distributed computing system targeting the edge site;
determining, by the one or more processors, execution metrics for the service based on the configuration choices and the evaluation of the service invocation, wherein the execution metrics satisfy the specification with high probability;
based on the execution metrics, determining a MIG configuration instance for the service; and
executing, by the one or more processors, the service utilizing the MIG configuration instance.

2. The computer-implemented method of claim 1, further comprising:
returning, by the one or more processors, execution results.

3. The computer-implemented method of claim 1, wherein the specification is a service level agreement.

4. The computer-implemented method of claim 1, wherein determining the configuration choices for the MIG configurations instances comprises applying a Markov Decision Process.

5. The computer-implemented method of claim 1, wherein the historical data comprises data related to graphics processing units in the distributed computing system, the data selected from the group consisting of: benchmarks and logs.

6. The computer-implemented method of claim 1, wherein determining the execution metrics comprises applying another DTMC.

7. The computer-implemented method of claim 1, wherein determining the MIG configuration instance for the service further comprises:
determining, by the one or more processors, that utilizing the edge site as a sole edge side to execute the service is suboptimal based on the specification;
automatically determining, by the one or more processors, an optimal strategy for utilizing a coalition of edge sites to execute the service; and
utilizing, by the one or more processors, the coalition of edge sites to execute the service in the MIG configuration instance.

8. The computer-implemented method of claim 7, wherein automatically determining the optimal strategy comprises applying a trained reinforcement learning algorithm.

9. The computer-implemented method of claim 8, further comprising:
implementing, by the one or more processors, a feedback loop, to continuously train the reinforcement learning algorithm based on historical data comprising results of the service invocation.

10. The computer-implemented method of claim 1, wherein the configuration choices for the MIG configurations instances comprise steady states, wherein each steady state comprises a value for each instance of a given graphics processing unit at the edge site.

11. The computer-implemented method of claim 10, wherein each graphics processing unit is partitioned into a maximum of seven instances.

12. The computer-implemented method of claim 11, wherein each instance comprises a graphics processing cluster slice.

13. The computer-implemented method of claim 12, wherein the configuration choices for the MIG configuration instances comprise adding, retaining, or deleting a graphics processing cluster slice for each graphics processing cluster slice of a MIG.

14. A computer system for determining multiple instance graphics processing unit (MIG) configuration instances in a distributed computing system, the computer system comprising:
a memory; and
one or more processors in communication with the memory, wherein the computer system is configured to perform a method, said method comprising:
obtaining, by the one or more processors, a service invocation for MIG resources for a service, wherein the service invocation comprises a specification defining performance parameters for the service;
encoding, by the one or more processors, the specification;
determining, by the one or more processors, based on accessing historical data, configuration choices for MIG configurations instances based on an edge site of the distributed computing system;
evaluating, by the one or more processors, utilizing the encoded specification and a Discrete Time Markov Chain (DTMC), the service invocation in a context of temporally relevant service invocations in the distributed computing system targeting the edge site;
determining, by the one or more processors, execution metrics for the service based on the configuration choices and the evaluation of the service invocation, wherein the execution metrics satisfy the specification with high probability;
based on the execution metrics, determining a MIG configuration instance for the service; and
executing, by the one or more processors, the service utilizing the MIG configuration instance.

15. The computer system of claim 14, the method further comprising:
returning, by the one or more processors, execution results.

16. The computer system of claim 14, wherein the specification is a service level agreement.

17. The computer system of claim 14, wherein determining the configuration choices for the MIG configurations instances comprises applying a Markov Decision Process.

18. The computer system of claim 14, wherein the historical data comprises data related to graphics processing units in the distributed computing system, the data selected from the group consisting of: benchmarks and logs.

19. The computer system of claim 14, wherein determining the MIG configuration instance for the service further comprises:
determining, by the one or more processors, that utilizing the edge site as a sole edge side to execute the service is suboptimal based on the specification;
automatically determining, by the one or more processors, an optimal strategy for utilizing a coalition of edge sites to execute the service; and
utilizing, by the one or more processors, the coalition of edge sites to execute the service in the MIG configuration instance.

20. A computer program product for determining multiple instance graphics processing unit (MIG) configuration instances in a distributed computing system, the computer program product comprising:
one or more computer readable storage media and program instructions collectively stored on the one or more computer readable storage media readable by at least one processing circuit to:
obtain a service invocation for MIG resources for a service, wherein the service invocation comprises a specification defining performance parameters for the service;
encode the specification;
determine, based on accessing historical data, configuration choices for MIG configurations instances based on an edge site of the distributed computing system;
evaluate, utilizing the encoded specification and a Discrete Time Markov chain, the service invocation in a context of temporally relevant service invocations in the distributed computing system targeting the edge site;
determine, execution metrics for the service based on the configuration choices and the evaluation of the service invocation, wherein the execution metrics satisfy the specification with high probability;
based on the execution metrics, determine a MIG configuration instance for the service; and
execute the service utilizing the MIG configuration instance.
